(19) United States
(12) Patent Application Publication
(10) Pub. No.: US 2026/0013672 A1
(43) Pub. Date: Jan. 15, 2026

(54) APPARATUSES AND METHODS FOR COOKING PLANT PRODUCTS

(71) Applicant: Rosalind Leggett, McDonough, GA (US)

(72) Inventor: Rosalind Leggett, McDonough, GA (US)

(21) Appl. No.: 18/771,695

(22) Filed: Jul. 12, 2024

(51) Int. Cl. A47J 43/18; A23L 5/10; A23L 11/45; A23L 11/50; A23L 19/00; A23L 31/00; B25G 1/10

(52) U.S. Cl. CPC A47J 43/18; A23L 5/10; A23L 11/45; A23L 11/50; A23L 19/03; A23L 31/00; B25G 1/102

(57) ABSTRACT

The disclosure herein provides an apparatus and method for cooking a vegetable that prevents destruction of the delicate vegetable structure. This disclosure also provides an apparatus and method for cooking a plant-based meat product that prevents destruction of the plant-based meat product.

### BACKGROUND OF THE INVENTION

Americans, on average, consume fewer fruits and vegetables and more meat than is recommended. A poor diet contributes significantly to obesity and chronic diseases in the United States. Incidence of obesity-related diseases, such as cardiovascular disease, type 2 diabetes, and stroke is at a historic level. Physicians are increasingly recommending a plant-based or plant-forward diet (e.g., the Mediterranean diet) to combat obesity and its associated morbidities. As such, tools and methods for cooking plant products such as vegetables and plant-based meats are desired.

### BRIEF SUMMARY OF THE INVENTION

Provided herein is a vegetable press for cooking a vegetable, the vegetable press comprising (a) a base defined by a top face and a bottom face, wherein the base has a weight sufficient to maintain the vegetable in a desired configuration on a cooking surface when the bottom face of the base engages the vegetable on the cooking surface; and (b) a handle extending upward from the top face of the base. Also provided herein is a method of cooking a vegetable on a cooking surface comprising orienting the vegetable on top of the cooking surface and pressing the vegetable with the vegetable press as provided herein.

This disclosure also provides a plant-based meat press for cooking a plant-based meat product, the plant-based meat press comprising (a) a base defined by a top face and a bottom face, wherein the base has a weight sufficient to maintain the plant-based meat product in a desired configuration on a cooking surface when the bottom face of the base engages the plant-based meat product on the cooking surface; and (b) a handle extending upward from the top face of the base. Also provided herein is a method of cooking a plant-based meat product on a cooking surface comprising orienting the plant-based meat product on top of the cooking surface and pressing the plant-based meat product with the plant-based meat press as provided herein.

### BRIEF DESCRIPTION OF THE DRAWINGS

The following figures show embodiments and are not intended to be limiting. The embodiments herein will be better understood from the following description with reference to the drawings.

FIG. 1 is a perspective view of an embodiment of the vegetable press of the present disclosure. FIG. 1 shows, inter alia, the handle and base of the vegetable press. Also shown are the ergonomic indentations on the bottom portion of the handle and the plurality of grooves on the bottom face of the base.

FIG. 2 is a side view of the device of FIG. 1. FIG. 2 shows, inter alia, the bottom face of the base and the plurality of grooves thereon. Also shown are the ergonomic indentations on the bottom portion of the handle.

FIG. 3 is a top view of the device of FIGS. 1 and 2. FIG. 3 shows, inter alia, the top face of the base and the handle, including the ergonomic indentations on the bottom portion of the handle.

FIG. 4 is a perspective view of an embodiment of the vegetable press of the present disclosure. FIG. 4 shows, inter alia, the handle and base of the vegetable press. The handle shown in FIG. 4 comprises a first and a second wood panel. Also shown are the ergonomic indentations on the bottom portion of the second wood panel.

FIG. 5 is a perspective view of an embodiment of the plant-based meat press of the present disclosure. FIG. 5 shows, inter alia, the handle and base of the plant-based meat press. Also shown are the ergonomic indentations on the bottom portion of the handle and the plurality of grooves on the bottom face of the base.

FIG. 6 is a side view of the device of FIG. 5. FIG. 6 shows, inter alia, the bottom face of the base and the plurality of grooves thereon. Also shown are the ergonomic indentations on the bottom portion of the handle.

FIG. 7 is a top view of the device of FIGS. 5 and 6. FIG. 7 shows, inter alia, the top face of the base and the handle, including the ergonomic indentations on the bottom portion of the handle.

FIG. 8 is a perspective view of an embodiment of the plant-based meat press of the present disclosure. FIG. 8 shows, inter alia, the handle and base of the plant-based meat press. The handle shown in FIG. 8 comprises a first and a second wood panel. Also shown are the ergonomic indentations on the bottom portion of the second wood panel.

### DETAILED DESCRIPTION OF THE INVENTION

The disclosure herein provides an apparatus and method for cooking a vegetable that prevents destruction of the delicate vegetable structure. This disclosure also provides an apparatus and method for cooking a plant-based meat product that prevents destruction of the plant-based meat product.

### I. Vegetable Press

In the disclosure to follow, initially described is a vegetable press for cooking a vegetable comprising a base defined by a top and bottom face, the base having a weight sufficient to maintain the vegetable in a desired configuration on a cooking surface when engaged by the bottom face of the base and a handle extending upward from the top face of the base.

### A. Apparatuses

Provided herein is a vegetable press for cooking a vegetable, the vegetable press comprising (a) a base defined by a top face and a bottom face, wherein the base has a weight sufficient to maintain the vegetable in a desired configuration on a cooking surface when the bottom face of the base engages the vegetable on the cooking surface; and (b) a handle extending upward from the top face of the base.

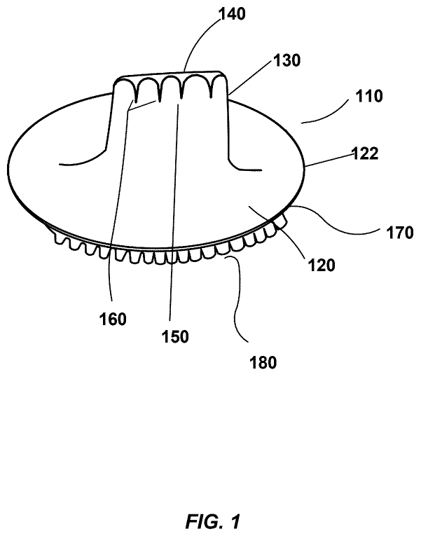

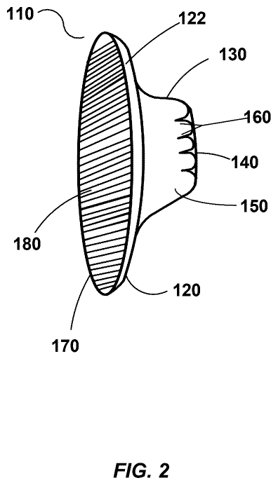

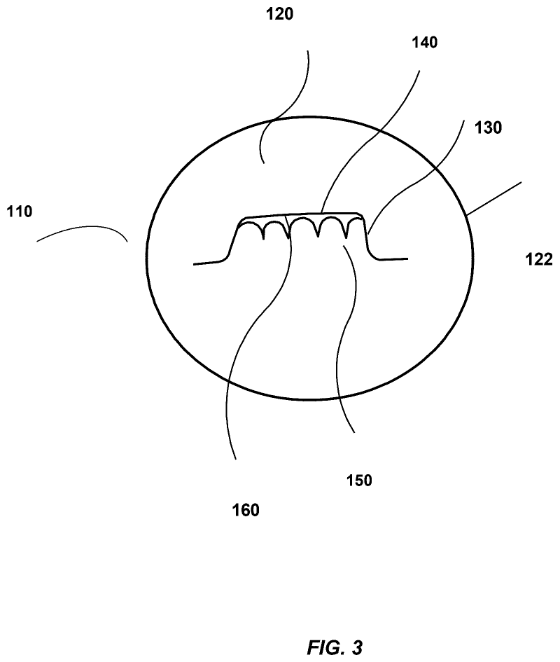

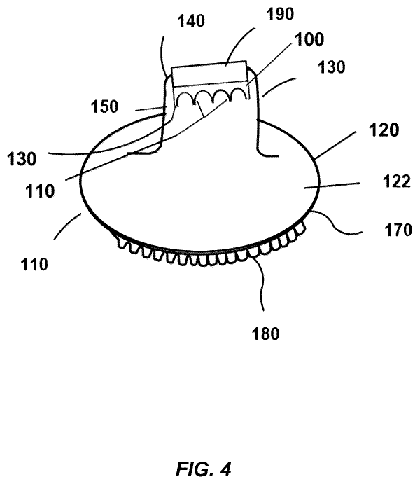

Referring to FIGS. 1-4, the vegetable press of the disclosure is represented in general at 110. The vegetable press includes a base 122 having a top face 120 and a bottom face 170. The bottom face of the base 170 may include a plurality of grooves 180. A handle 130 extends upwardly from the top face 120 of the base 122. The handle includes a top portion 140 and a bottom portion 150. The handle may include a plurality of ergonomic indentations 160 on the bottom portion 150 of the handle 130. The handle may further include a first wood panel 190 on the top portion of the handle 140 and a second wood panel 100 on the bottom portion of the handle 150. The second wood panel may comprise a plurality of ergonomic indentations 112 on a bottom surface 132 of the second wood panel 100.

The base has a weight sufficient to maintain the vegetable in a desired configuration on a cooking surface. In some embodiments, the desired configuration of the vegetable is substantially unbroken. By way of example, the vegetable press may be used when cooking a mushroom such that the vegetable press engages with the top of the mushroom and the bottom of the mushroom is in contact with the cooking surface. In this example, the vegetable press has a defined weight such that the mushroom remains substantially unbroken. As used herein, the term substantially unbroken refers to in majority part, whole, in one piece, or complete.

In some embodiments, the vegetable press described herein is used to form the vegetable into a desired shape. In some embodiments, the vegetable press is used to form the vegetable into a steak shape, i.e., a shape of substantially uniform thickness. By way of example, the vegetable press may be used when cooking a portabella mushroom such that when the vegetable press engages with the top of the mushroom, the mushroom is formed into a steak shape of substantially uniform thickness.

The weight of the base may vary depending on the vegetable being cooked. The vegetable presses disclosed herein may comprise bases having a different weight from one another. For example, a vegetable press described herein may have a base having a lesser weight for use when cooking a delicate vegetable such as a mushroom. In another example, a vegetable press may have a base having a greater weight for use when cooking a firmer vegetable such as a brassica. In some embodiments, the weight of the base is at least 200 grams. In some embodiments, the weight of the base is between 200 and 1500 grams, for example, 300, 400, 500, 600, 700, 800, 900, 1,000, 1,100, 1,200, 1,300, 1,400, or 1,500 grams.

The vegetable press may comprise a material suitable for maintaining a vegetable in a desired configuration on a cooking surface. Materials and features thereof will be apparent to one skilled in the art. In some embodiments, the vegetable press comprises a material with a low thermal conductivity. In some embodiments, the vegetable press comprises a metal, for example iron, steel, aluminum, or titanium. In some embodiments the vegetable press comprises iron.

The vegetable press described herein comprises, among other parts, a handle and a base. The base may comprise a material suitable for engaging the vegetable on the cooking surface. Suitable materials for the base will be apparent to one skilled in the art. In some embodiments, the base comprises a material with a high thermal conductivity. In some embodiments, base comprises a metal, for example, iron, steel, aluminum, or titanium. The base may further comprise a nonstick coating on top of the underlying material, for example, a ceramic, polytetrafluoroethylene, enamel, silica, or anodized aluminum coating. By way of example, the base comprises iron with an enamel coating.

The base of vegetable press described herein may comprise a diameter, thickness, and shape suitable for cooking the vegetable. Specific attributes will be apparent to one skilled in the art considering the qualities of the vegetable being cooked. For example, a larger diameter may be needed to cook a larger vegetable, for example a portabella mushroom, compared to a Brussels sprout. In some embodiments, the base of the vegetable press is between 5 and 11 inches in diameter, for example 6, 7, 8, 9, or 10 inches in diameter. In some embodiments, the base of the vegetable press is greater than or equal to one-half inch in thickness, for example, one, one and a half, or two inches in thickness. In some embodiments, the base of the vegetable press is substantially round. As used herein, substantially round refers to a shape which is approximately round or round. For example, a circle, an oval, or an ellipse.

In some embodiments, the bottom face of the base is flat. In some embodiments, the bottom face of the base comprises a plurality of grooves formed therein. The amount, shape, depth, and width of the grooves may differ depending on the vegetable being cooked. For example, a smaller vegetable such as a Brussels sprout may require more grooves of a smaller width placed closer together than a larger vegetable such as a portobello mushroom, for which larger, fewer, and farther apart grooves may be desired.

The vegetable press described herein comprises a handle extending upwardly from the top face of the base. The handle may comprise a material suitable for grasping the vegetable press while cooking a vegetable. In some embodiments, the handle material is different from that of the base. Suitable materials for the handle will be apparent to one skilled in the art. In some embodiments, the handle comprises a material with a low thermal conductivity. In some embodiments, the handle comprises a wood, a plastic, or a rubber. The handle may connect to the top face of the base at two points. In some embodiments, the handle is welded to the base. In other embodiments, the handle is attached to the base by at least two screws.

In some embodiments, handle material is the same as that of the base, for example, a metal. The handle may further comprise a first wood panel attached to a top portion of the handle and a second wood panel attached to a bottom portion of the handle. In some embodiments, the second wood panel further comprises a surface for facilitating ergonomic handling of the vegetable press. In some embodiments, the second wood panel further comprises a plurality of ergonomic indentations on a bottom surface of the second wood panel. In some embodiments, the first wood panel and the second wood panel are attached to the handle by at least two screws. In some embodiments, the first wood panel and the second wood panel are attached to the handle by two, four, or six screws.

The vegetable press herein may be used for cooking any vegetable. In some embodiments, the vegetable a mushroom. In some embodiments, the vegetable is a tuber, for example a yam or a potato. In some embodiments, the vegetable is a squash, for example, a zucchini, a summer squash, a butternut squash, or an acorn squash. In some embodiments, the vegetable is a brassica, for example, a cauliflower, a broccoli, a cabbage, a kohlrabi, or a Brussels sprout.

### B. Methods

Also provided herein is a method of cooking a vegetable on a cooking surface comprising orienting the vegetable on top of the cooking surface and pressing the vegetable with the vegetable press as describe above or elsewhere herein. In some embodiments, the method of cooking a vegetable provided herein further comprises a step of forming the vegetable into a desired shape before orienting the vegetable on top of the cooking surface. In some embodiments, the method of cooking a vegetable further comprises a step of forming the vegetable into a steak shape, i.e., substantially flat on the top and bottom with a substantially circular or oval shape, before orienting the vegetable on top of the cooking surface. The method of cooking a vegetable described herein may be used on a variety of cooking surfaces, which will be apparent to one skilled in the art. For example, the method of cooking a vegetable may be used on a stovetop, a grill, or a griddle.

The method of cooking a vegetable described herein may be used for cooking any vegetable. In some embodiments, the vegetable a mushroom. In some embodiments, the vegetable is a tuber, for example a yam or a potato. In some embodiments, the vegetable is a squash, for example, a zucchini, a summer squash, a butternut squash, or an acorn squash. In some embodiments, the vegetable is a brassica, for example, a cauliflower, a broccoli, a cabbage, a kohlrabi, or a Brussels sprout.

### I. Plant-Based Meat Press

This disclosure also provides a plant-based meat press for cooking a plant-based meat product comprising a base defined by a top and bottom face, the base having a weight sufficient to maintain the plant-based meat product in a desired configuration on a cooking surface when engaged by the bottom face of the base and a handle extending upward from the top face of the base.

### A. Apparatuses

Provided herein is a plant-based meat press for cooking a plant-based meat product, the plant-based meat press comprising (a) a base defined by a top face and a bottom face, wherein the base has a weight sufficient to maintain the plant-based meat product in a desired configuration on the cooking surface when the bottom face of the base engages the plant-based meat product on the cooking surface; and (b) a handle extending upwardly from the top face of the base.

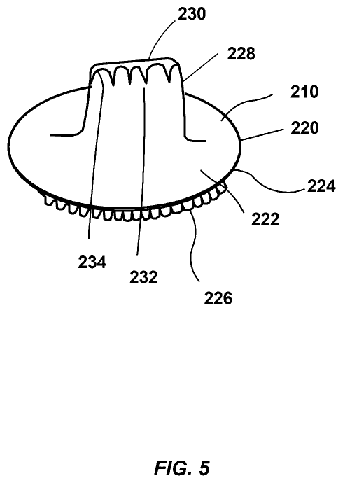

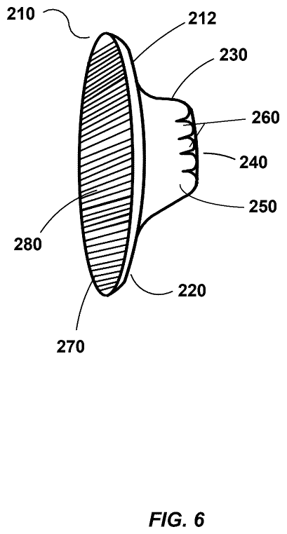

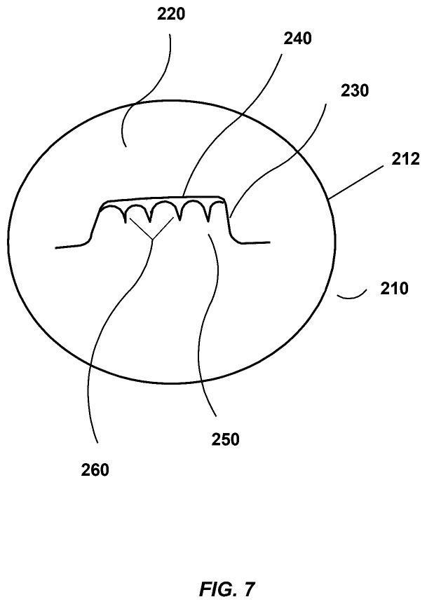

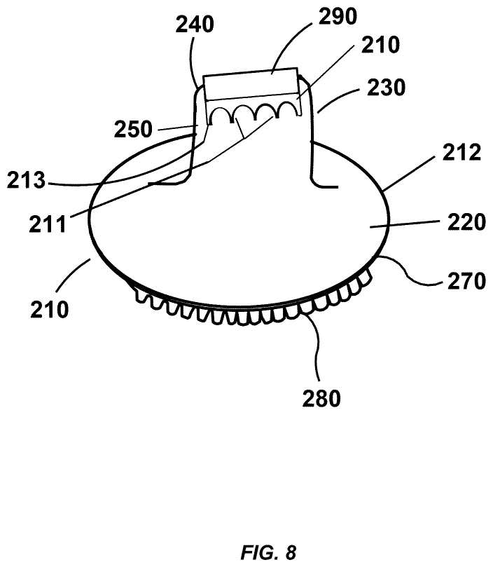

Referring to FIGS. 5-8, the plant-based meat press of the disclosure is represented in general at 210. The plant-based meat press includes a base 220 having a top face 222 and a bottom face 224. The bottom face of the base 224 may include a plurality of grooves 226. A handle 228 extends upwardly from the top face 222 of the base 220. The handle includes a top portion 230 and a bottom portion 232. The handle may include a plurality of ergonomic indentations 234 on the bottom portion 232 of the handle 228. The handle may further include a first wood panel 226 on the top portion of the handle 230 and a second wood panel 238 on the bottom portion of the handle 232. The second wood panel may comprise a plurality of ergonomic indentations 240 on a bottom surface 242 of the second wood panel 238.

The base has a weight sufficient to maintain the plant-based meat product in a desired configuration on a cooking surface. In some embodiments, the desired configuration of the plant-based meat product is substantially unbroken. By way of example, the plant-based meat press may be used when cooking a tofu piece such that the plant-based meat press engages with the top of the tofu piece and the bottom of the tofu piece is in contact with the cooking surface. In this example, the plant-based meat press has a defined weight such that the tofu piece remains substantially unbroken. As used herein, the term substantially unbroken refers to in majority part whole, in one piece, or complete.

In some embodiments, the plant-based meat press described herein is used to form the plant-based meat product into a desired shape. In some embodiments, the plant-based meat press is used to form the plant-based meat product into a burger shape, i.e., a substantially round shape of substantially uniform thickness. By way of example, the plant-based meat press may be used when cooking a plant-based ground meat substitute such that when the plant-based meat press engages with the top of the plant-based ground meat substitute, the plant-based ground meat substitute is formed into a burger shape of substantially uniform thickness.

The weight of the base may vary depending on the plant-based meat product being cooked. The plant-based meat presses disclosed herein may comprise bases having a different weight from one another. For example, the plant-based meat press described herein may have a base having a lesser weight for use when cooking a delicate plant-based meat product such as a plant-based burger. In another example, the plant-based meat press may have a base having a greater weight for use when cooking a firmer plant-based meat product such as a plant-based sausage. In any case, the preferred weight of the base may vary depending on the formulation of the plant-based meat product. In some embodiments, the weight of the base is at least 200 grams. In some embodiments, the weight of the base is between 200 and 1500 grams, for example, 300, 400, 500, 600, 700, 800, 900, 1,000, 1,100, 1,200, 1,300, 1,400, or 1,500 grams.

The plant-based meat press may comprise a material suitable for maintaining a plant-based meat product in a desired configuration on a cooking surface. Materials and features thereof will be apparent to one skilled in the art. In some embodiments, the plant-based meat press comprises a material with a low thermal conductivity. In some embodiments, the plant-based meat press comprises a metal, for example iron, steel, aluminum, or titanium. In some embodiments the plant-based meat press comprises iron.

The plant-based meat press described herein comprises, among other parts, a handle and a base. The base may comprise a material suitable for engaging the plant-based meat product on the cooking surface. Suitable materials for the base will be apparent to one skilled in the art. In some embodiments, the base comprises a material with a low thermal conductivity. In some embodiments, base comprises a metal, for example, iron, steel, aluminum, or titanium. The base may further comprise a nonstick coating on top of the underlying material, for example, a ceramic, polytetrafluoroethylene, enamel, silica, or anodized aluminum coating. By way of example, the base comprises iron with an enamel coating.

The base of plant-based meat press described herein may comprise a diameter, thickness, and shape suitable for cooking the plant-based meat product. Specific attributes will be apparent to one skilled in the art considering the qualities of the plant-based meat being cooked. For example, a larger diameter may be needed to cook a larger plant-based meat product, for example a plant-based meat burger, compared to a plant-based nugget. In any case, the preferred diameter may vary depending on the size of the plant-based product. In some embodiments, the base of the plant-based meat press is between 5 and 11 inches in diameter, for example 6, 7, 8, 9, or 10 inches in diameter. In some embodiments, the base of the plant-based meat press is greater than or equal to one-half inch in thickness, for example, one, one and a half, or two inches in thickness. In some embodiments, the base of the plant-based meat press is substantially round. As used herein, substantially round refers to a shape which is approximately round or round. For example, a circle, an oval, or an ellipse.

In some embodiments, the bottom face of the base is flat. In some embodiments, the bottom face of the base comprises a plurality of grooves formed therein. The amount, shape, depth, and width of the grooves may differ depending on the plant-based meat being cooked. For example, a smaller plant-based meat product such as a plant-based nugget may require more grooves of a smaller width placed closer together than a larger plant-based meat product such as a plant-based meat burger, for which larger, fewer, and farther apart grooves may be desired.

The plant-based meat press described herein comprises a handle extending upwardly from the top face of the base. The handle may comprise a material suitable for grasping the plant-based meat press while cooking a plant-based meat product. In some embodiments, the handle material is different from that of the base. Suitable materials for handle will be apparent to one skilled in the art. In some embodiments, the handle press comprises a material with a low thermal conductivity. In some embodiments, the handle comprises a wood, a plastic, or a rubber. The handle may connect to the top face of the base at two points. In some embodiments, the handle is welded to the base. In other embodiments, the handle is attached to the base by at least two screws.

In some embodiments, handle material is the same as that of the base, for example, a metal. The handle may further comprise a first wood panel attached to a top portion of the handle and a second wood panel attached to a bottom portion of the handle. In some embodiments, the second wood panel further comprises a surface for facilitating ergonomic handling of the plant-based meat press. In some embodiments, the second wood panel further comprises a plurality of ergonomic indentations on a bottom surface of the second wood panel. In some embodiments, the first wood panel and the second wood panel are attached to the handle by at least two screws. In some embodiments, the first wood panel and the second wood panel are attached to the handle by two, four, or six screws.

The plant-based meat press herein may be used for cooking any plant-based meat product, including but not limited to tofu, tempeh, seitan, plant-based sausage, ground meat substitute, and plant-based chicken nuggets. In some embodiments, the plant-based meat product is tofu. In some embodiments, the plant-based meat product is tempeh. In some embodiments, the plant-based meat product is a ground meat substitute, for example, a plant-based meat burger.

### B. Methods

Also provided herein is a method of cooking a plant-based meat product on a cooking surface comprising orienting the plant-based meat product on top of the cooking surface and pressing the plant-based meat product with the plant-based meat press as describe above or elsewhere herein. In some embodiments, the method of cooking a plant-based meat product provided herein further comprises a step of forming the plant-based meat product into a desired shape before orienting the plant-based meat product on top of the cooking surface. In some embodiments, the method of cooking a plant-based meat product further comprises a step of forming the plant-based meat product into a burger shape, i.e., a substantially round shape of substantially uniform thickness, before orienting the plant-based meat product on top of the cooking surface. The method of cooking a plant-based meat product described herein may be used on a variety of cooking surfaces, which will be apparent to one skilled in the art. For example, the method of cooking a plant-based meat product may be used on a stovetop, a grill, or a griddle.

The method of cooking a plant-based meat product described herein may be used for cooking any plant-based meat product, including but not limited to tofu, tempeh, seitan, plant-based sausage, ground meat substitute, and plant-based chicken nuggets. In some embodiments, the plant-based meat product is tofu. In some embodiments, the plant-based meat product is tempeh. In some embodiments, the plant-based meat product is a ground meat substitute, for example, a plant-based meat burger.

What is claimed is:

1. A vegetable press for cooking a vegetable comprising:
(a) a base defined by a top face and a bottom face, wherein the base has a weight sufficient to maintain the vegetable in a desired configuration on a cooking surface when the bottom face of the base engages the vegetable on the cooking surface; and
(b) a handle extending upward from the top face of the base.

2. The vegetable press of claim 1, wherein the desired configuration is substantially unbroken.

3. The vegetable press of claim 1, wherein the weight of the base is at least 200 grams.

4. The vegetable press of claim 3, wherein the weight of the base is between 200 grams and 1500 grams.

5. The vegetable press of claim 1, wherein the vegetable press comprises a metal.

6. The vegetable press of claim 5, wherein the metal is iron.

7. The vegetable press of claim 1, wherein the base is between 5 and 11 inches in diameter.

8. The vegetable press of claim 1, wherein the base is greater than or equal to one-half inch in thickness.

9. The vegetable press of claim 1, wherein the base is substantially round.

10. The vegetable press of claim 1, wherein the bottom face of the base further comprises a plurality of grooves formed therein.

11. The vegetable press of claim 1, wherein the handle comprises a metal.

12. The vegetable press of claim 11, wherein the metal is iron.

13. The vegetable press of claim 1, wherein the handle comprises a wood.

14. The vegetable press of claim 1, wherein the handle comprises a plastic.

15. The vegetable press of claim 1, wherein the handle comprises a rubber.

16. The vegetable press of claim 1, wherein the handle connects to the top face of the base at two points.

17. The vegetable press of claim 1, wherein the handle further comprises a plurality of ergonomic indentations on a bottom portion of the handle, and wherein a top portion of the handle is substantially flat.

18. The vegetable press of claim 1, wherein the handle further comprises:
(a) a first wood panel attached to a top portion of the handle; and
(b) a second wood panel attached to a bottom portion of the handle.

19. The vegetable press of claim 18, wherein the second wood panel further comprises a plurality of ergonomic indentations on a bottom surface of the second wood panel.

20. The vegetable press of claim 18, wherein the first wood panel and the second wood panel are attached to the handle by at least two screws.

21. The vegetable press of claim 1, wherein the vegetable is a mushroom.

22. The vegetable press of claim 1, wherein the vegetable is a tuber.

23. The vegetable press of claim 22, wherein the tuber is a yam or a potato.

24. The vegetable press of claim 1, wherein the vegetable is a squash.

25. The vegetable press of claim 1, wherein the vegetable is a brassica.

26. The vegetable press of claim 25, wherein the brassica is selected from the group consisting of: a broccoli, a cauliflower, or a cabbage.

27. A method of cooking a vegetable on a cooking surface comprising:
(a) Orienting the vegetable on top of the cooking surface; and
(b) Pressing the vegetable with the vegetable press of claim 1.

28. The method of claim 27, wherein the vegetable is a mushroom.

29. The method of claim 27, wherein the vegetable is a brassica.

30. The method of claim 29, wherein the brassica is selected from the group consisting of: a broccoli, a cauliflower, or a cabbage.

31. A plant-based meat press for cooking a plant-based meat product comprising:
(a) a base defined by a top face and a bottom face, wherein the base has a weight sufficient to maintain the plant-based meat product in a desired configuration on the cooking surface when the bottom face of the base engages the plant-based meat product on the cooking surface; and
(b) a handle extending upwardly from the top face of the base.

32. The plant-based meat press of claim 31, wherein the desired configuration is substantially unbroken.

33. The plant-based meat press of claim 31, wherein the weight of the base is at least 200 grams.

34. The plant-based meat press of claim 33, wherein the weight of the base is between 200 grams and 1500 grams.

35. The plant-based meat press of claim 31, wherein the plant-based meat press comprises a metal.

36. The plant-based meat press of claim 35, wherein the metal is iron.

37. The plant-based meat press of claim 31, wherein the base is between 5 and 11 inches in diameter.

38. The plant-based meat press of claim 31, wherein the base is greater than or equal to one-half inch in thickness.

39. The plant-based meat press of claim 31, wherein the base is substantially round.

40. The plant-based meat press of claim 31, wherein the bottom face of the base further comprises a plurality of grooves formed therein.

41. The plant-based meat press of claim 31, wherein the handle comprises a metal.

42. The plant-based meat press of claim 41, wherein the metal is iron.

43. The plant-based meat press of claim 31, wherein the handle comprises a wood.

44. The plant-based meat press of claim 31, wherein the handle comprises a plastic.

45. The plant-based meat press of claim 31, wherein the handle comprises a rubber.

46. The plant-based meat press of claim 31, wherein the handle connects to the top face of the base at two points.

47. The plant-based meat press of claim 31, wherein the handle further comprises a plurality of ergonomic indentations on a bottom portion of the handle, and wherein a top portion of the handle is substantially flat.

48. The plant-based meat press of claim 31, wherein the handle further comprises:
(a) a first wood panel attached to a top portion of the handle; and
(b) a second wood panel attached to a bottom portion of the handle.

49. The plant-based meat press of claim 48, wherein the second wood panel further comprises a plurality of ergonomic indentations on a bottom surface of the second wood panel.

50. The plant-based meat press of claim 48, wherein the first wood panel and the second wood panel are attached to the handle by at least two screws.

51. The plant-based meat press of claim 31, wherein the plant-based meat product is tofu.

52. The plant-based meat press of claim 31, wherein the plant-based meat product is tempeh.

53. The plant-based meat press of claim 31, wherein the plant-based meat product is a ground meat substitute.

54. A method of cooking a plant-based meat product on a cooking surface comprising:
(a) Orienting the plant-based meat product on top of the cooking surface; and
(b) Pressing the plant-based meat product with the plant-based meat press of claim 31.

55. The method of claim 54, wherein the plant-based meat product is tofu.

56. The method of claim 54, wherein the plant-based meat product is tempeh.

57. The method of claim 54, wherein the plant-based meat product is a ground meat substitute.
